(19) United States
(12) Patent Application Publication
(10) Pub. No.: US 2007/0085941 A1
(43) Pub. Date: Apr. 19, 2007

(54) Liquid crystal display with frame having reinforcing part

(75) Inventors: Hsueh-Tien Chang, Miao-Li (TW); Ping-Jung Lin, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/580,447

(22) Filed: Oct. 13, 2006

(30) Foreign Application Priority Data
Oct. 14, 2005 (TW) 94135980

(51) Int. Cl. G02F 1/1333

(52) U.S. Cl. 349/58

(57) ABSTRACT

An exemplary liquid crystal display (1) includes a liquid crystal panel (13), and a frame (18). The liquid crystal panel has a block (134) outwardly extending from a side surface (132) thereof. The frame includes a side wall (181) defining a gap (189) thereat, and a reinforcing part (188) at a bottom portion of the frame that bounds the gap. The liquid crystal panel is received in the frame, and the block is received in the gap.

### FIELD OF THE INVENTION

The present invention relates to liquid crystal displays (LCDs), and more particularly to a liquid crystal display with a frame having a reinforcing part.

### GENERAL BACKGROUND

Liquid crystal displays are commonly used as display devices for compact electronic apparatuses, because they not only provide good quality images but are also very thin.

One method for manufacturing a liquid crystal panel of a liquid crystal display is the so-called vacuum suction method. In this method, liquid crystal material is injected between two opposite glass substrates of the liquid crystal panel, and an entrance for the liquid crystal material in the liquid crystal panel is hermetically sealed. Thereby, in general, a stopping block protrudes outwardly from a side portion of the liquid crystal panel.

Referring to FIG. 6, a typical liquid crystal display 6 includes an upper polarizing film 61, a liquid crystal panel 62, a lower polarizing film 63, and a backlight module assembly 64, arranged in that order from top to bottom. The liquid crystal panel 62 has a block 622 outwardly extending from a side surface 624 thereof. The backlight module assembly 64 includes a brightness enhancement film (BEF) 65, a diffusing film 66, and a light guide plate (LGP) 67, arranged in that order from top to bottom. The backlight module assembly 64 further includes three light emitting diodes (LEDs) 69 disposed adjacent to a light incident surface 672 of the light guide plate 67. The liquid crystal display 6 further includes a plastic frame 68, which fittingly accommodates the upper polarizing film 61, liquid crystal panel 62, lower polarizing film 63 and backlight module assembly 64 therein.

The plastic frame 68 has a side wall 682 defining a gap 684 corresponding to the block 622 of the liquid crystal panel 62. A bottom surface 686 of the plastic frame 68 which bounds the gap 684 is flat. When the liquid crystal display 6 is assembled, the upper polarizing film 61, the liquid crystal panel 62, the lower polarizing film 63, the BEF 65, the diffusing film 66, the light guide plate 67 and the light emitting diodes 69 are received in the plastic frame 68. The block 622 is thus received in the gap 684.

In making the liquid crystal display 6, one objective is that it be mechanically stable. To this end, it is desirable that the plastic frame 68 be thick. However, a thick plastic frame 68 may make the liquid crystal display 6 unduly thick. The opposite competing objective is to make the liquid crystal display 6 thin. To this end, it is desirable that the plastic frame 68 be thin. However, in such case, the side wall 682 adjacent to the gap 684 may be particularly thin and weak. Moreover, when the plastic frame 68 is manufactured by an injection molding method, the plastic frame 68 is liable to distort during a cooling process due to stresses in the side wall 682 at the gap 684 being significantly different from stresses in other parts of the plastic frame 68. Thus, the liquid crystal display 6 may exceed tolerances or be unduly prone to breakage or displacement.

What is needed, therefore, is a liquid crystal display that can overcome the above-described deficiencies.

### SUMMARY

In a preferred embodiment, a liquid crystal display includes a liquid crystal panel and a frame. The liquid crystal panel has a block outwardly extending from a side surface thereof. The frame includes a side wall defining a gap thereat, and a reinforcing part at a bottom portion of the frame that bounds the gap. The liquid crystal panel is received in the frame, and the block is received in the gap.

Other aspects, advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the described embodiments. In the drawings, like reference numerals designate corresponding parts throughout various views, and all the views are schematic.

FIG. 1 is an exploded, isometric view of a liquid crystal display according to a first embodiment of the present invention, the liquid crystal display including an upper polarizing film.

FIG. 2 is an assembled view of the liquid crystal display of FIG. 1, but omitting the upper polarizing film thereof.

FIG. 3 is an enlarged, cross-sectional view of part of the liquid crystal display shown in FIG. 2, taken along line III-III thereof.

FIG. 4 is similar to FIG. 3, but showing a corresponding view in the case of a liquid crystal display according to a second embodiment of the present invention.

FIG. 5 is similar to FIG. 3, but showing a corresponding view in the case of a liquid crystal display according to a third embodiment of the present invention.

FIG. 6 is an exploded, isometric view of a conventional liquid crystal display.

### DETAILED DESCRIPTION OF PREFERRED EMBODIMENTS

Reference will now be made to the drawings to describe the preferred embodiments in detail.

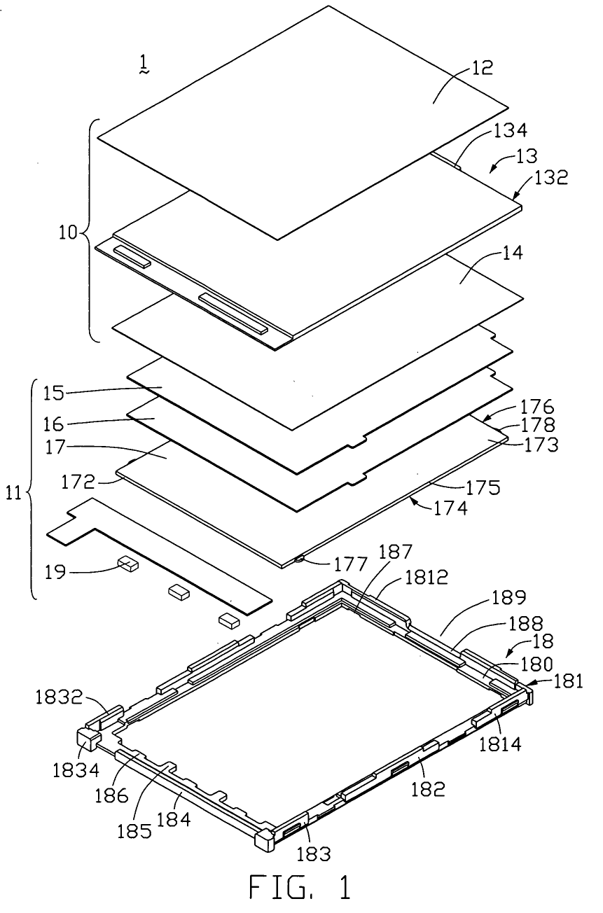

Referring to FIG. 1, a liquid crystal display 1 according to a first embodiment of the present invention is shown. The liquid crystal display 1 includes a liquid crystal panel assembly 10, a backlight module assembly 11 adjacent to the liquid crystal panel assembly 10, and a frame 18 fittingly accommodating the liquid crystal panel assembly 10 and the backlight module assembly 11.

The liquid crystal panel assembly 10 includes an upper polarizing film 12, a liquid crystal panel 13, and a lower polarizing film 14, arranged in that order from top to bottom. The liquid crystal panel 13 includes two opposite substrates (not shown), and a liquid crystal layer (not shown) between the substrates. The substrates can be made of glass. The liquid crystal layer includes liquid crystal material. A typical method for manufacturing the liquid crystal panel 13 is the so-called vacuum suction method. In this method, liquid crystal material is injected between the opposite substrates, and an entrance (not labeled) at a side surface 132 of the liquid crystal panel 13 for the liquid crystal material is hermetically sealed. Thereby, in general, a block 134 outwardly extending from the side surface 132 is formed.

The backlight module assembly 11 includes a BEF 15, a diffusing film 16, and a light guide plate 17, arranged in that order from top to bottom. The backlight module assembly 11 further includes three light emitting diodes 19 serving as light sources and being located adjacent to a light incident surface 172 of the light guide plate 17.

The light guide plate 17 further includes a light emitting surface 173 perpendicularly connecting with the light incident surface 172, a bottom surface 174 opposite to the light emitting surface 173, two opposite first side surfaces 175 perpendicularly connecting with the light incident surface 172, and a second side surface 176 opposite to the light incident surface 172. That is, the light incident surface 172, the first side surfaces 175, and the second side surface 176 are between the light emitting surface 173 and the bottom surface 174. The diffusing film 16 is disposed adjacent to the light emitting surface 173 of the light guide plate 17. Two first ears 177 outwardly extend from the first side surfaces 175 respectively. The first ears 177 are at end portions (not labeled) of the respective first side surfaces 175 that are adjacent to the light incident surface 172. Two second ears 178 (only one visible) outwardly extend from the second side surface 176. The second ears 178 are at corresponding end portions (not labeled) of the second side surface 176, respectively. The light guide plate 17 can be made from polycarbonate (PC) or polymethyl methacrylate (PMMA), and can be manufactured by an injection molding method.

The frame 18 includes a spacing board 180, a first side wall 181, two opposite second side walls 182, two opposite third side walls 183, and a fourth side wall 184. The first side wall 181, the second side walls 182, the third side walls 183, and the fourth side wall 184 integrally extend from the spacing board 180.

The spacing board 180 is generally frame-shaped, and perpendicularly extends inward from inner surfaces (not labeled) of the first side wall 181, the second side walls 182, the third side walls 183, and the fourth side wall 184. Thus the frame 18 defines a generally rectangular space (not labeled) for accommodating the liquid crystal panel assembly 10, the BEF 15, the diffusing film 16, and the light guide plate 17. A plurality of steps (not labeled) are defined on the spacing board 180 at the space. Two first protrusions 185 and three second protrusions 186 are formed at an inner surface (not labeled) of the spacing board 180 at the fourth side wall 184. The first protrusions 185 and the second protrusions 186 extend into the space, are parallel to each other, and are alternately arranged. The second protrusions 186 are shorter than the first protrusions 185, whereby three recesses are defined at the second protrusions 186 respectively. The light emitting diodes 19 can be respectively disposed in the recesses. In particular, the light emitting diodes 19 can be arranged to abut the second protrusions 186 respectively. The frame 18 further defines four notches 187 positioned at three inner sides (not labeled) of the spacing board 180 respectively. Each notch 187 is located corresponding to a respective one of the first ears 177 or a respective one of the second ears 178 of the light guide plate 17. That is, the first ears 177 and the second ears 178 can be received in the notches 187 respectively. The frame 18 is preferably made from polycarbonate, plastic, or another suitable material.

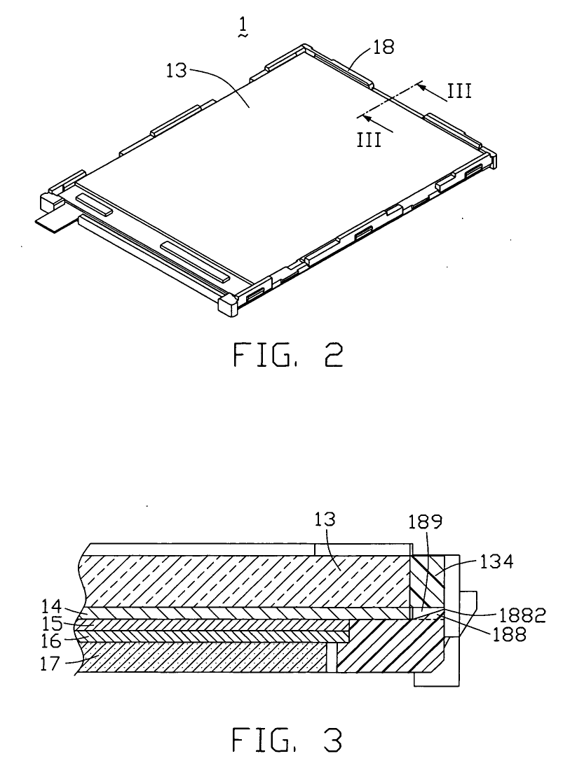

The first side wall 181 has a generally symmetrical U-shape, and includes a first arm 1812, and two opposite second arms 1814. The first arm 1812 extends along a corresponding short side of the spacing board 180. The second arms 1814 integrally extend perpendicularly from opposite ends of the first arm 1812 along two opposite long sides of the spacing board 180 which connect with the short side. A gap 189 is defined at the first arm 1812 of the first side wall 181, corresponding to the block 134 of the liquid crystal panel 13. Also referring to FIG. 2 and FIG. 3, a reinforcing rib 188 is formed at a bottom portion (not labeled) of the first side wall 181 which bounds the gap 189. The reinforcing rib 188 has a generally triangular cross-section. In the illustrated embodiment, the reinforcing rib 188 has a triangular prism structure, with a height of the reinforcing rib 188 increasing along a direction away from a center axis of the frame 18. The reinforcing rib 188 can be manufactured as an integral part of the frame 18 by an injection molding method. That is, the frame 18 including the reinforcing rib 188 can be made from polycarbonate, plastic or another suitable material. Each second side wall 182 is generally bar-shaped, and is aligned with a respective one of the second arms 1814. Each third side wall 183 has a generally asymmetrical L-shape, and includes a third arm 1832 and a fourth arm 1834. The third arm 1832 extends along the corresponding long side of the spacing board 180, and is aligned with a respective one of the second side walls 182. The fourth arm 1834 extends along a corresponding short side of the spacing board 180. The fourth side wall 184 is connected with only one of the fourth arms 1834. That is, an opening (not labeled) is defined between the fourth side wall 184 and the other fourth arm 1834.

In assembly of the liquid crystal display 1, the liquid crystal panel assembly 10, the BEF 15, the diffusing film 16, the light guide plate 17, and the light emitting diodes 19 are received in the frame 18. The block 134 is received in the gap 189 of the frame 18, and an intervening space exists between a top ridge 1892 of the reinforcing rib 188 and a bottom surface (not labeled) of the block 134. That is, the reinforcing rib 188 is separate from the block 134.

The reinforcing rib 188 is formed at the thinner portion of the first side wall 181, and can enhance a mechanical strength of the first side wall 181 adjacent the gap 189. Further, with this configuration, when the frame 18 is manufactured by an injection molding method, distortion of the frame 18 due to stress differentials can be reduced or even be eliminated. Thus, the liquid crystal display 1 can be readily made according to tolerances and be mechanically stable.

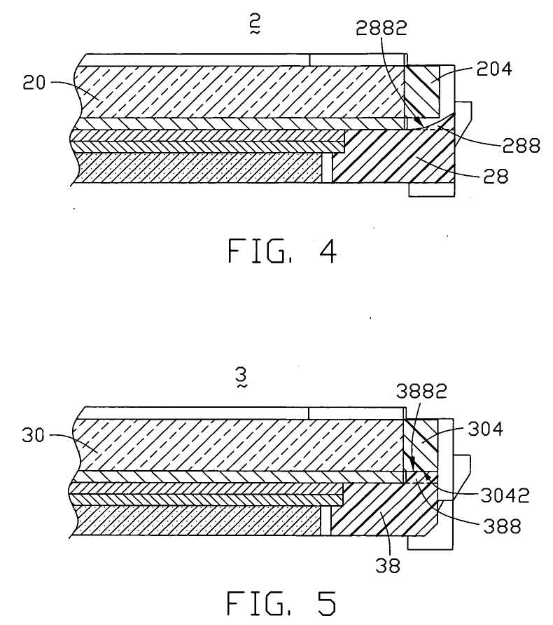

Referring to FIG. 4, a liquid crystal display 2 according to a second embodiment of the present invention is similar to the liquid crystal display 1. However, the liquid crystal display 2 includes a liquid crystal panel 20, and a frame 28. A reinforcing rib 288 of the frame 28 has a curved top surface 2882, and is separate from a block 204 of the liquid crystal panel 20. The liquid crystal display 2 can achieve advantages similar to those of the liquid crystal display 1.

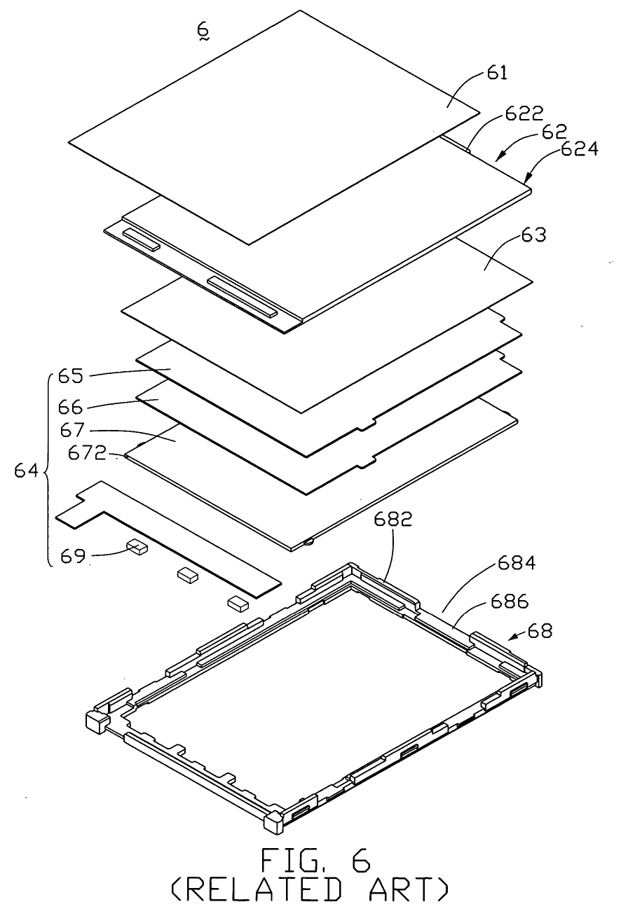

Referring to FIG. 5, a liquid crystal display 3 according to a third embodiment of the present invention is similar to the liquid crystal display 1. However, the liquid crystal display 3 includes a liquid crystal panel 30 and a frame 38. A reinforcing rib 388 of the frame 38 has a rectangular profile, and a top surface 3882 of the rectangular reinforcing rib 388 abuts a bottom surface 3042 of a block 304 of the liquid crystal panel 30. The liquid crystal display 3 can achieve advantages similar to those of the liquid crystal display 1.

Further or alternative embodiments may include the following alternative configurations of the reinforcing ribs 188, 288, 388. For example, the reinforcing rib 188, 288, 388 can have an elliptic cross-section or a hemispherical cross-section, or have any other suitable shape that can enhance the mechanical strength of the corresponding frame 18, 28, 38.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal display comprising:
a liquid crystal panel having a block outwardly extending from a side surface thereof; and
a frame receiving the liquid crystal panel, the frame comprising:
a side wall defining a gap thereat receiving the block; and
a reinforcing part at a bottom portion of the frame that bounds the gap.

2. The liquid crystal display in claim 1, wherein the reinforcing part has a triangular cross-section.

3. The liquid crystal display in claim 2, wherein the reinforcing part has a triangular prism structure.

4. The liquid crystal display in claim 2, wherein a height of the reinforcing part increases along a direction away from a center axis of the frame.

5. The liquid crystal display in claim 1, wherein the reinforcing part has a curved top surface.

6. The liquid crystal display in claim 1, wherein the reinforcing part has a rectangular cross-section.

7. The liquid crystal display in claim 1, wherein the reinforcing part is a part of the side wall at the gap.

8. The liquid crystal display in claim 1, wherein the block is separate from the reinforcing part.

9. The liquid crystal display in claim 1, wherein the block abuts the reinforcing part.

10. The liquid crystal display in claim 1, wherein the frame comprising the side wall and the reinforcing part is made from polycarbonate or plastic.

11. The liquid crystal display in claim 1, wherein the reinforcing part is at a portion of the frame that is thinner than other portions of the frame.

12. The liquid crystal display in claim 1, further comprising a backlight module assembly also received in the frame.

13. A liquid crystal display comprising:
a liquid crystal panel having a block outwardly extending from a side surface thereof;
a polarization film attached on an undersurface of the liquid crystal panel; and
a frame receiving the liquid crystal panel and said polarization film, the frame comprising:
a side wall defining a gap thereat receiving the block; and
a raised reinforcement portion formed at a bottom portion of the frame;
wherein
said raised reinforcement portion does not contact the undersurface of the liquid crystal panel while essentially located at a same level with the polarization film.
